(19) United States
(12) Patent Application Publication
(10) Pub. No.: US 2016/0024609 A1
(43) Pub. Date: Jan. 28, 2016

(54) ROLLER HEARTH FURNACE AND METHOD FOR THE HEAT TREATMENT OF METAL SHEETS

(71) Applicants: SCHWARTZ GMBH, Simmerath (DE); THYSSENKRUPP STEEL EUROPE AG, Dortmund (DE); KIRCHHOFF AUTOMATIVE DEUTSCHLAND GMBH, Attendorn (DE)

(72) Inventors: Markus Löcker, Finnentrop (DE); Franz Josef Lenze, Lennestadt (DE); Axel Schrooten, Dortmund (DE); Alexander Wilden, Simmerath (DE); Harald Lehmann, Duisburg (DE)

(73) Assignees: Schwartz GmbH, Simmerath (DE); ThyssenKrupp Steel Europe AG, Dortmund (DE); Kirchhoff Automative Deutschland GmbH, Attendorn (DE)

(21) Appl. No.: 14/443,510

(22) PCT Filed: Nov. 18, 2013
(86) PCT No.: PCT/EP2013/074022

§ 371 Date: Sep. 24, 2015

(30) Foreign Application Priority Data
Nov. 19, 2012 (DE) 10 2012 221 120.9

(51) Int. Cl. C21D 9/00; C22C 38/00; C21D 8/02; C21D 9/46; F27B 9/30; F27B 9/02

(52) U.S. Cl. CPC C21D 9/0012; F27B 9/30; F27B 9/028; C21D 8/0205; C21D 9/46; C22C 38/00

(57) ABSTRACT

The invention relates to a roller hearth furnace for the heat treatment of coated metal sheets as well as to a corresponding method. The objective of the invention is to put forward a roller hearth furnace that allows the alternating processing of AlSi-coated metal sheets and metal sheets with zinc alloy coatings for hot-working, whereby considerably less effort is involved for the alternating procedure than is the case in the state of the art. The roller hearth furnace according to the invention for the heat treatment of coated metal parts is characterized in that it has at least a first zone and a second zone, whereby in the first zone, a temperature below the melting temperature of the AlSi deposits or a temperature of more than approximately 900° C. [1652° F.] can be maintained, whereas in the second zone, a temperature of more than approximately 870° C. [1598° F.] can be reached.

The invention relates to a roller hearth furnace for the heat treatment of metal sheets as well as to a corresponding method.

Nowadays, the automotive industry is striving to develop vehicles that have the lowest possible fuel consumption. A commonly employed way to cut back on fuel consumption is, for example, to reduce the weight of the vehicle. However, in order to comply with increasingly stringent safety requirements, the structural steels employed for the car body need to have a greater strength along with a lower weight. This is normally achieved by the process of so-called press-hardening. Here, a sheet metal part is heated to approximately 800° C. to 1000° C. and subsequently shaped and quenched in a cooled tool. As a result, the strength of the part increases by up to a factor of three.

When it comes to process reliability and cost-effectiveness, continuous furnaces have proven their worth for the heat treatment. Here, the metal parts that are to be treated are continuously conveyed through the furnace. As an alternative, chamber furnaces can also be used in which the metal parts are fed in batches into a chamber, heated up there, and subsequently removed again.

When it comes to press-hardening, a fundamental distinction is made between the direct process and the indirect process.

In the indirect process, a blank is stamped out of a coil, cold-worked, and the component that has been pre-shaped in this manner then undergoes the heat treatment. After the heat treatment, the hot component is placed into the press and press-hardened in an indirectly cooled tool. Subsequently, the components are trimmed once again and sand-blasted in order to remove any scaling that might be present.

In the direct process, a blank is likewise stamped out of a coil; however, in this case, no pre-shaping is carried out, but rather the blank is placed directly into the furnace. After the heat treatment, the hot blank is placed into the press and shaped in an indirectly water-cooled tool and, at the same time, press-hardened. Subsequently, the shaped components are trimmed once again if necessary.

For both processes, so-called roller hearth furnaces have proven their worth in terms of process reliability and cost-effectiveness. An example of an alternative furnace design is the walking-beam furnace, in which the metal parts are transported through the furnace by means of walking beams. Multi-deck chamber furnaces are also gaining in significance.

Since the components are pre-shaped for the indirect process, their complex shapes mean that they have to be conveyed through or placed into the furnace chamber on workpiece carriers. Moreover, continuous furnaces for this process are usually fitted with inlet and outlet locks since, for the indirect process, uncoated components have to be heat-treated. In order to avoid scaling of the surface of the component, such a furnace has to be operated with inert gas. These inlet and outlet locks serve to prevent air from entering the furnace. Chamber furnaces for this process can likewise be equipped with a lock. However, with this furnace design, it is also possible to change the atmosphere in the furnace chamber for each cycle. Continuous furnaces for this process have to be equipped with a return system for the workpiece carriers in order to effectuate the circulation of the workpiece carriers. Ceramic conveyor rollers are used in these furnaces. Only the inlet and outlet tables as well as the return conveyors for the workpiece carriers are equipped with metal conveyor rollers.

When it comes to continuous furnaces for the direct process, there is no need to use workpiece carriers. Consequently, the design is somewhat simpler than that of continuous furnaces for the indirect process. Instead of the blanks being conveyed on workpiece carriers, the blanks used in the direct process are laid directly onto ceramic conveyor rollers and conveyed through the furnace. These furnaces can be operated with or without inert gas. Here, too, a standard feature is that the furnace housing is welded so as to be gas-tight. Another advantage of this design is the positive effect that the conveying roller has on the uniform heating up of the metal parts that are to be treated: the stationary rollers that are likewise heated up by the furnace heating system additionally—by means of radiation and heat conduction—heat up the metal parts that are being transported on these rollers and that are thus in contact with them. Moreover, these furnaces can be operated with a much lower input of energy since there are no workpiece carriers that can cool off while they are being returned after having passed through the furnace and therefore would have to be heated up again when they pass through the furnace anew. The direct process is thus preferred when it comes to the use of continuous furnaces.

The metal sheets used in automotive construction are not supposed to rust. Scaling should also be avoided during the working process since, before any further processing, at the latest before the welding or coating processes, such scaling has to be removed, which is both labor-intensive and costly. However, since untreated steel sheets would inevitably develop scaling in the presence of oxygen at the high temperatures required for press hardening, it is common practice to use coated metal sheets and/or to carry out the heat treatment process in the absence of oxygen.

Normally, aluminum-silicon-coated (AlSi-coated) metal sheets are used for press-hardened components for the automotive industry. The coating prevents the metal sheets from rusting and also prevents the occurrence of scaling of the hot metal sheets during the transfer from the furnace to the press. On the one hand, the AlSi of the coating diffuses into the steel surface and, on the other hand, it forms a dense AlSi oxide layer that protects the base material against further scaling.

The most severe drawback of direct press-hardening in the roller hearth furnaces described above lies in the fact that the AlSi-coated blanks are laid directly onto the ceramic conveying rollers, as a result of which strong thermo-chemical reactions occur between the AlSi coating and the ceramic rollers.

The rollers that are currently used in roller hearth furnaces are hollow rollers made of sintered mullite (3Al₂O₃.2SiO₂) or solid rollers made of quartz material. The quartz material rollers consist of more than 99% SiO₂ and have an application limit of approximately 1100° C., but with the drawback that they bend under their own weight at approximately 700° C. to 800° C. Rollers made of sintered mullite can be used under load at temperatures of up to 1350° C. without significant bending occurring. The major advantage of both materials is their high thermal shock resistance. However, both materials have a very high affinity towards reacting with molten aluminum so as to form different aluminum-silicate or even silicide compounds. The AlSi coating can melt during the heat treatment. During operation, at a certain temperature on the rollers, a doughy to liquid AlSi coating is formed on the ceramic furnace rollers, particularly in the front part of the conveying segment. This layer becomes smaller as it proceeds along the length of the conveying segment since the AlSi becomes alloyed with iron stemming from the basic material during the passage through the furnace. The place of the conveying segment where there is no more free AlSi depends on the heating curve and thus on the installed heating output in the furnace as a function of the conveying segment as well as of the metal sheet thickness and the coating thickness.

As an alternative to AlSi-coated metal sheets, metal sheets with zinc alloy coatings for hot-working have recently come to be used, for example, metal sheets with a zinc-nickel coating, which is sold under the name Gamma Protect by Thyssen Krupp Steel Europe AG, for example, for processing in the manufacture of car body parts. The press-hardening process described above can be carried out with these metal sheets analogously and fundamentally using the same roller hearth furnaces that are used for the press-hardening of AlSi-coated metal sheets. However, for various reasons, it is not readily possible to process metal sheets with zinc alloy coatings for hot-working on rollers that are contaminated with AlSi residues. Therefore, when the furnaces are switched over from AlSi-coated metal sheets to metal sheets with zinc alloy coatings for hot-working, there is a need for laborious retooling in that, for example, the rollers in question have to be replaced. Since the rollers can reach process temperatures in the order of magnitude of 1000° C., and since replacing the rollers is hardly or not at all possible at these temperatures, the furnace has to first cool off before being retooled and it subsequently has to be heated up again, which is time-consuming, uses a great deal of energy and entails a loss of production.

Therefore, the objective of the invention is to put forward a roller hearth furnace that allows the alternating processing of AlSi-coated metal sheets and metal sheets with zinc alloy coatings for hot-working, whereby considerably less effort is involved for the alternating procedure here than is the case in the state of the art.

According to the invention, this objective is achieved by a roller hearth furnace having the features of the independent claim 1. Advantageous refinements of the roller hearth furnace ensue from the subordinate claims 2 to 5.

Another objective of the invention lies in putting forward a method for the alternating processing of AlSi-coated metal sheets and metal sheets with zinc alloy coatings for hot-working while using a roller hearth furnace according to the invention.

This objective is achieved by a method having the features of claim 6. An advantageous refinement of the method ensues from subordinate claim 7.

The roller hearth furnace according to the invention for the heat treatment of coated metal parts is characterized in that the furnace has at least two different temperature zones, whereby in the first zone, a temperature below the melting temperature of the AlSi deposits or a temperature of more than approximately 900° C. can be maintained, whereas in the second zone, a temperature of more than approximately 870° C. can be reached.

During the heat treatment of AlSi-coated metal sheets in a roller hearth furnace, a layer of AlSi can form on the rollers in the front part of the furnace. This layer has doughy, pasty consistency or else it can be liquid.

In the direct process, the coated metal sheets are conveyed into the hot furnace and are in direct contact with the rollers that have been heated up to the process temperature or almost up to the process temperature. Here, the process temperature is usually approximately 930° C. On the other hand, the melting temperature of the AlSi is approximately 600° C., so that the AlSi melts quickly at the process temperature. The process, during which the molten AlSi becomes solid again due to diffusion processes, takes a certain amount of time. Steel manufacturers prescribe, for example, a process time of 300 to 360 seconds. While the coated metal sheet is being transported through the furnace, it heats up. The heating rate depends, on the one hand, on the installed heating output in the furnace as well as on the distribution of this heating output and, on the other hand, on the sheet thickness and coating thickness. Depending on the throughput rate of the coated sheet through the furnace, under a proper process control, there is a place in the furnace where the molten AlSi will have diffused into the metal sheet matrix. Up to this place, AlSi residues can become deposited on the rollers in the roller hearth furnace. Downstream from this place, as seen in the conveying direction, there is no longer any free AlSi remaining on the metal sheet, so that no more AlSi melt can become deposited on any of the rollers beyond this place. A roller hearth furnace that is suitable for the heat treatment of AlSi-coated metal sheets has a length that is selected in such a way that the metal sheet that is to be treated remains is in the furnace for at least the processing time, for example, 300 seconds.

The processing time can be shorter for the heat treatment of metal sheets with zinc alloy coatings for hot-working. In particular, zinc-nickel alloy coatings such as, for example, those sold by Thyssen Krupp Steel Europe AG under the name Gamma Protect, are characterized by their very short processing times. Moreover, the diffusion process of the zinc alloy coatings calls for a slightly lower temperature—approximately 870° C. to 900° C.—than the temperature needed for the diffusion process of an AlSi coating, which is carried out at approximately 930° C. Therefore, it is possible to keep a first zone of a roller hearth furnace that is suited for the heat treatment of AlSi-coated metal sheets at a temperature that lies below the melting temperature of the AlSi deposits. If this first zone is selected so large that, as seen in the conveying direction, there are no more AlSi residues on the rollers in a second zone that is located beyond this first zone, then, with a proper process control, a metal sheet with zinc alloy coatings for hot-working can be heat-treated in the same furnace without a need to replace or clean the rollers of the first zone that are contaminated with AlSi residues. Since the temperature in the first zone is kept below the melting temperature of the AlSi deposits, no appreciable amount of AlSi can come off the rollers and react with the zinc alloy coatings for hot-working.

In an advantageous embodiment, in the first zone, that is to say, the zone with the contaminated rollers, a temperature of approximately 300° C. to 750° C., ideally of approximately 500° C. to 600° C., and especially below approximately 575° C. can be maintained, while a temperature of more than approximately 870° C. prevails in the second zone. As an alternative, a temperature of more than 900° C. can likewise be maintained in the first zone. When metal sheets with zinc alloy coatings for hot-working are processed, the sheets are preheated at a temperature in the first zone that is up to the maximum level of the prevailing zone temperature, whereby the temperature reliably remains below the melting temperature of the AlSi deposits and any AlSi deposits that might be present on the rollers do not melt. Due to the preheating, the metal sheets in the second zone can be heated up more quickly to the process temperature of approximately 890° C. that is needed for the heat treatment of metal sheets with zinc alloy coatings for hot-working. If AlSi-coated metal sheets are to be processed again, the temperature is raised and maintained, also in the first zone, to the process temperature of approximately 930° C. that is required for the heat treatment of AlSi-coated metal sheets.

It has proven to be advantageous if the zones can be essentially separated from each other thermally, that is to say, especially if the first zone can be thermally separated from the second zone. A separating means has proven to be advantageous for this purpose. A separating means can be, for instance, a wall made of a thermally insulating material. This wall can extend from above essentially perpendicular to the conveying direction all the way to just above the plane of the rollers and can separate the furnace chamber of the first zone from that of the second zone, so that only a gap remains for the rollers and for the conveyed metal sheet that is to be treated.

The thermal separating means can be installed so as to be immovable in the furnace chamber. An immovable thermal separating means is easy to create and it is maintenance-free, in spite of the operating temperatures prevailing in the furnace.

In an alternative embodiment, the thermal separating means is configured so that it can be pushed in and pulled out. If a metal sheet with zinc alloy coatings for hot-working is being processed, the thermal separating means can be pushed in, so that the zones are essentially separated from each other thermally, in particular the first zone is essentially separated from the second zone thermally. In contrast, if AlSi-coated metal sheets are to be processed, then the thermal separating means can be pulled out so that the zones are no longer thermally separated and an essentially homogeneous temperature is established in the entire furnace.

Additional advantages, special features and practical refinements of the invention can be gleaned from the subordinate claims and from the depiction below of preferred embodiments, on the basis of the figures.

The figures show the following:

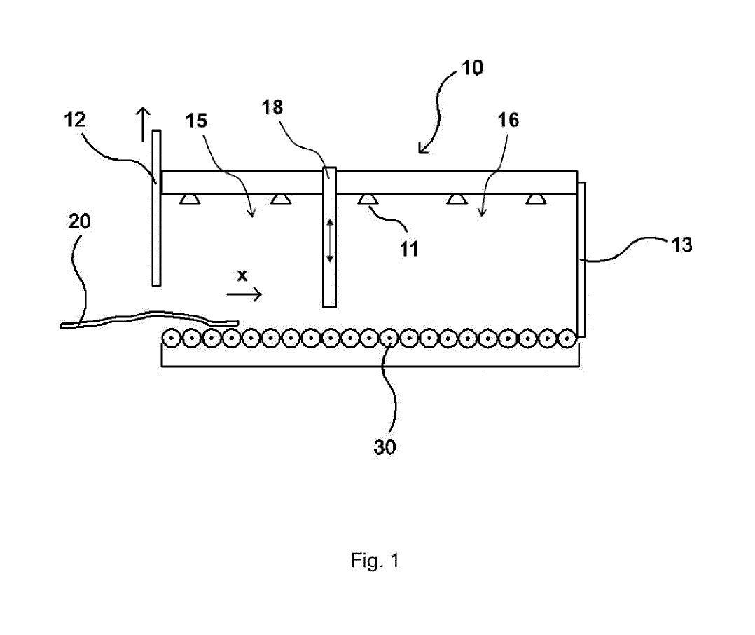

FIG. 1 a roller hearth furnace;

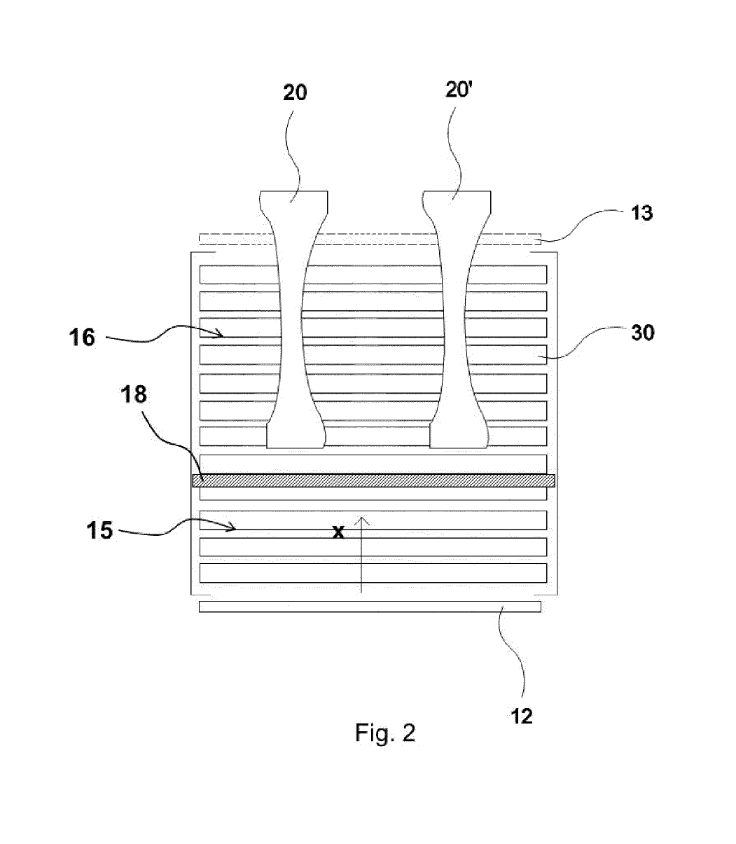

FIG. 2 workpieces during the transport through a roller hearth furnace;

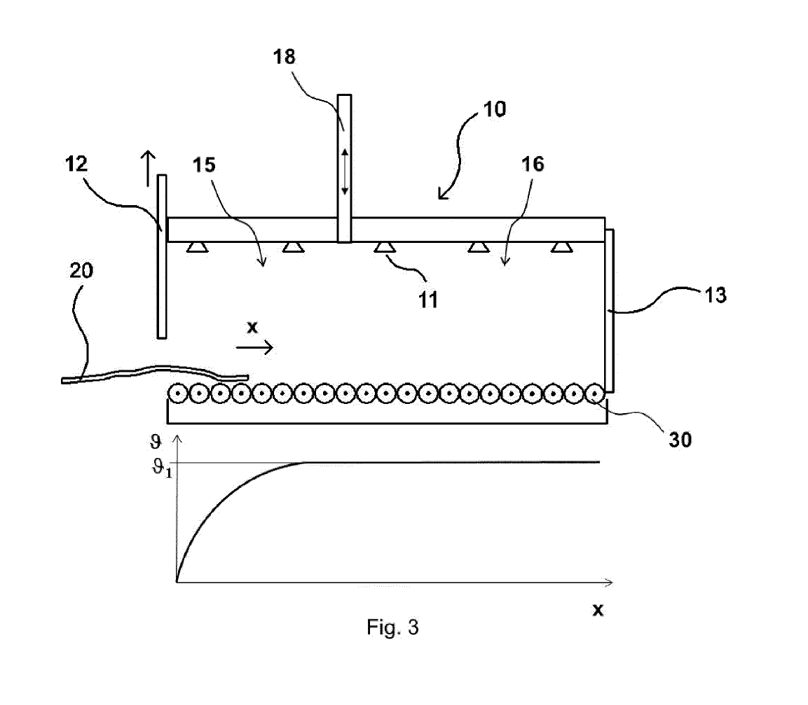

FIG. 3 a roller hearth furnace with a temperature distribution of AlSi-coated metal sheets as they are being conveyed through the furnace;

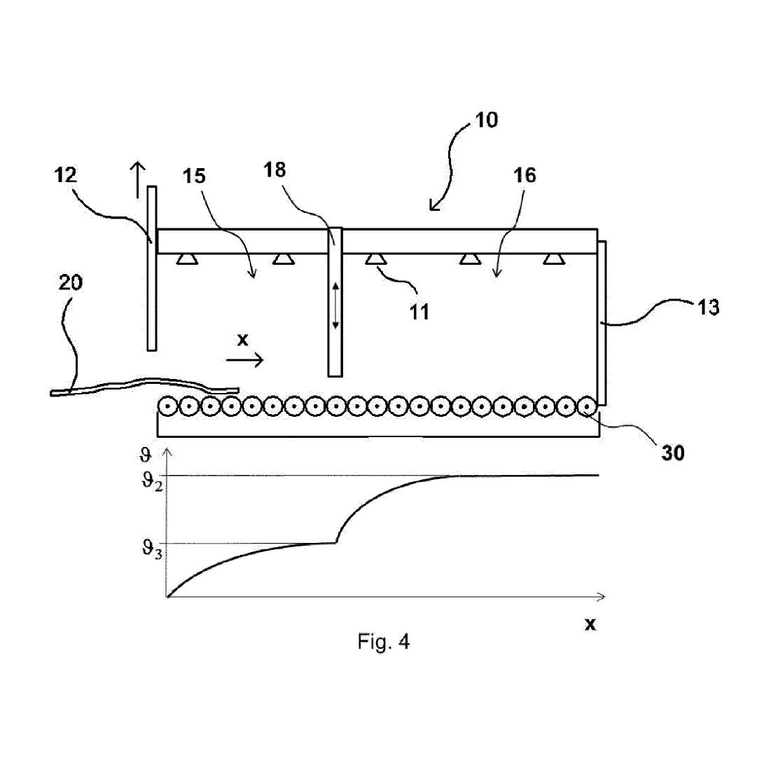

FIG. 4 a roller hearth furnace with a temperature distribution of metal sheets with zinc alloy coatings for hot-working and as they are being conveyed through the furnace.

FIG. 1 shows a schematic view of a roller hearth furnace 10. A workpiece 20 is conveyed into the furnace chamber on conveying means in the form of rollers 30 via a sliding partition 12 that is located on the inlet side and that separates the interior of the furnace vis-à-vis the outside atmosphere and that can be opened and closed. In the furnace chamber, the workpiece 20 undergoes its heat treatment in that it is heated up by heating means 11. Possible heating means 11 include, for example, gas burners or electric heating elements. In this process, the workpiece is conveyed further on the rollers 20 through the furnace chamber. Once the workpiece 20 has been conveyed completely into the furnace chamber, the sliding partition 12 located on the inlet side is closed. In order to then convey the workpiece 20 out of the furnace chamber, there is a cover 13 on the outlet side opposite from the cover 12 on the inlet side, and this cover 13 is likewise configured as a sliding partition that can be opened and closed. When the workpiece is to be conveyed out of the furnace chamber, this sliding partition 13 on the inlet side opens and the workpiece 20 is conveyed out of the furnace 10 by means of the rollers 30. In the furnace, there is also a thermal separation means 18 that can be moved in the vertical direction. As an alternative, the thermal separation means 18 can also installed so as to be immovable. The thermal separation means separates a first zone 15 from a second zone 16. In the position shown in the drawing, it has moved maximally downwards in the direction of the rollers 30, so that, between the rollers 30 and the bottom of the thermal separation means 18, a gap is retained that is dimensioned in such a way that a workpiece 20 can move past without touching the thermal separation means 18.

In a top view, FIG. 2 shows how two workpieces 20, 20′ are conveyed in parallel through the furnace 10. The two workpieces 20, 20′ rest on conveying means in the form of rollers 30 that, by rotating, convey the workpieces 20, 20′ in parallel through the furnace chamber. The inlet and outlet sides of the furnace can be opened by means of sliding partitions 12, 13 in order to allow the workpieces 20, 20′ to pass through. After the workpieces 20, 20′ have passed through, the sliding partitions 12, 13 are closed once again. The thermal separation means 18 is also depicted in the drawing. It extends over the entire inner width of the furnace chamber and separates the first zone 15 from a second zone 16.

FIG. 3 once again shows a schematic view of a roller hearth furnace 10 according to the invention. In the situation depicted here, the thermal separation means 18 is pulled out of the furnace 10, so that the first zone 15 is not thermally separated from the second zone 16. This position is intended for the processing of AlSi-coated metal sheets 20, 20′. However, in an alternative embodiment, these metal sheets can also be processed with immovable thermal separation means. A temperature of approximately 930° C. [1706° F.] prevails in both zones 15, 16. The temperature of AlSi-coated metal sheets 20, 20′ being conveyed through the furnace 10 is plotted in the diagram below the view of the furnace 10. The metal sheets 20, 20′ are at room temperature at the furnace inlet, that is to say, when they pass the sliding partition 12 on the inlet opening side. In the hot furnace atmosphere and due to heating by means of the heating means 11, they soon reach a temperature θ₁, for example, approximately 930° C., which is maintained until they leave the furnace 10.

FIG. 4 shows a schematic view of a roller hearth furnace 10 according to the invention in the situation for the processing of metal sheets with zinc alloy coatings for hot-working 20, 20′. The thermal separation means 18 is pushed into the furnace 10 so that the first zone 15 is thermally separated from the second zone 16, as is also the case in the alternative embodiment with the immovable thermal separation means 18. In the first zone, a temperature θ₃ is established, for example, up to approximately 575° C. In the second zone 16, in contrast, a temperature of approximately 890° C. prevails.

The temperature of metal sheets with zinc alloy coatings for hot-working 20, 20′ that are being conveyed through the furnace 10 is plotted in the diagram below the view of the furnace 10. The metal sheets 20, 20′ are at room temperature at the furnace inlet, that is to say, as they pass the sliding partition 12 on the inlet opening side. In the hot furnace atmosphere and due to heating by means of the heating means 11, they soon reach a temperature θ₃, for example, up to approximately 575° C. The metal sheets 20, 20′ are conveyed underneath the thermal separation means 18, which is pushed into the furnace 10, into the second zone 16, where a temperature θ₂ of approximately 890° C. prevails. The metal sheets 20, 20′ heat up to this temperature quickly and remain at this temperature until they leave the furnace 10. If AlSi-coated metal sheets 20, 20′ were heat-treated in the process presented in the description of FIG. 3 before the processing of the metal sheets with zinc alloy coatings for hot-working 20, 20′, then AlSi residues might be present on the rollers 30 of the first zone 15. These residues do not melt at the relatively low temperature θ₃ of up to approximately 575° C., so that they do not contaminate the metal sheets with zinc alloy coatings for hot-working 20, 20′ that are being conveyed on them. The place of the thermal separation means 18 is selected in such a way that, downstream from this place, as seen in the conveying direction x, there is no longer any free AlSi on the metal sheets 20, 20′, even in case of the most unfavorable constellation of AlSi-coated metal sheets 20, 20′ with large sheet and layer thicknesses and minimal heating output, and the diffusion process is completed, at least on the direct surface of the metal sheets 20, 20′. Consequently, there cannot be any AlSi residues on the rollers 30 in the second zone 16 that would contaminate the subsequently processed metal sheets with zinc alloy coatings for hot-working 20, 20′.

The thermal separation means 18 can be configured in such a way that it ends at a variable height above the plane of the rollers 30. For this purpose, the thermal separation means 18 can be pushed entirely or only partially into the furnace chamber. In this manner, if the metal sheets 20, 20′ that are to be treated have different thicknesses or if the workpieces 20, 20′ that are to be treated have been pre-shaped differently in terms of their dimensions, then the thermal separation can be optimized. The free cross section between the thermal separation means 18 and the rollers 30 can be selected to be minimal for each workpiece that is to be treated, so that the heat exchange between the first zone 15 and the second zone 16 is minimal. As a result, the temperatures in the two zones 15, 16 can be kept within narrower tolerances and the heating curve of the metal sheets when they enter the second zone 16 can be optimized.

The embodiments shown here constitute merely examples of the present invention and therefore must not be construed in a limiting fashion. Alternative embodiments considered by the person skilled in the art are likewise encompassed by the scope of protection of the present invention.

### LIST OF REFERENCE NUMERALS

10 furnace, roller hearth furnace
11 heating means
12 cover inlet opening, sliding partition
13 cover outlet opening, sliding partition
15 first zone
16 second zone
18 thermal separation means
20, 20′ workpiece
30 roller
x conveying direction
θtemperature
θ₁ temperature 1
θ₂ temperature 2
θ₃ temperature 3

1-8. (canceled)

9. A method for the alternating processing of AlSi-coated metal sheets and metal sheets with zinc alloy coatings for hot-working in a roller hearth furnace, characterized in that, when AlSi-coated metal sheets are processed, a temperature of more than approximately 900° C. is maintained in all of the zones of the roller hearth furnace, whereas when metal sheets with zinc alloy coatings for hot-working are processed, a temperature below the melting temperature of the AlSi deposits is maintained in the first zone of the roller hearth furnace where adhesions of AlSi residues can be present on the rollers, whereas a temperature of more than approximately 870° C. is maintained in the second zone and in any conceivable additional zones of the roller hearth furnace downstream from the first zone as seen in the conveying direction.

10. The method for the alternating processing of AlSi-coated metal sheets and metal sheets with zinc alloy coatings for hot-working in a roller hearth furnace according to claim 1, characterized in that, when the furnace is switched over from the processing of AlSi-coated metal sheets to the processing of metal sheets with zinc alloy coatings for hot-working, a thermal separation means is inserted into the roller hearth furnace between the first zone that has rollers that might be contaminated with AlSi deposits and the second zone.

11. A roller hearth furnace for the alternating heat treatment of metal parts that are AlSi-coated and of metal parts that are provided with zinc alloy coatings, said roller hearth furnace being equipped with rollers as conveying means for the workpieces that are to be processed, characterized in that the furnace has at least a first zone and a second zone, whereby in the first zone, a temperature of 575° C. at the maximum or a temperature of more than approximately 900° C. can be maintained, whereas in the second zone, a temperature of at least approximately 870° C. can be reached, whereby the first zone can be thermally separated from the second zone and from conceivable additional zones by means of a thermal separation means, whereby said thermal separation means can be pushed into and pulled out of the furnace chamber.
